(19) United States
(12) Patent Application Publication
(10) Pub. No.: US 2021/0138587 A1
(43) Pub. Date: May 13, 2021

(54) THREE-DIMENSIONAL SHAPED ARTICLE PRODUCING POWDER, THREE-DIMENSIONAL SHAPED ARTICLE PRODUCING COMPOSITION, AND PRODUCTION METHOD FOR THREE-DIMENSIONAL SHAPED ARTICLE

(71) Applicant: SEIKO EPSON CORPORATION, Tokyo (JP)

(72) Inventors: Naoko SHIMA, Shiojiri-shi (JP); Takeshi MIYASHITA, Suwa-shi (JP); Jun TAKIZAWA, Chino-shi (JP)

(21) Appl. No.: 17/090,196

(22) Filed: Nov. 5, 2020

(30) Foreign Application Priority Data
Nov. 8, 2019 (JP) 2019-203000

(51) Int. Cl. B23K 26/342; B33Y 10/00; B33Y 70/00; B22F 1/00; B23K 26/00; B23K 26/08; B23K 26/14

(52) U.S. Cl. CPC B23K 26/342; B33Y 10/00; B33Y 70/00; B22F 2304/10; B23K 26/0006; B23K 26/0869; B23K 26/1464; B22F 1/0011

(57) ABSTRACT

A three-dimensional shaped article producing powder according to the present disclosure includes a plurality of metal particles, and is used for producing a three-dimensional shaped article by laminating a plurality of layers while joining the metal particles to one another by irradiation with a laser beam, wherein as the metal particles, first metal particles and second metal particles having a composition different from the first metal particles are included. A content ratio of the first metal particles in the three-dimensional shaped article producing powder is higher than a content ratio of the second metal particles, and a reflectance of a peak wavelength component of the laser beam at 25° C. with respect to the first metal particles is smaller than a reflectance of a peak wavelength component of the laser beam at 25° C. with respect to the second metal particles.

The present application is based on, and claims priority from JP Application Serial Number 2019-203000, filed on Nov. 8, 2019, the disclosure of which is hereby incorporated by reference herein in its entirety.

### BACKGROUND

### 1. Technical Field

The present disclosure relates to a three-dimensional shaped article producing powder, a three-dimensional shaped article producing composition, and a production method for a three-dimensional shaped article.

### 2. Related Art

Recently, a three-dimensional shaping method that is a lamination method, in which model data of a three-dimensional object is divided into a large number of two-dimensional sectional layer data, and thereafter, while sequentially shaping sectional members corresponding to the respective two-dimensional sectional layer data, the sectional members are sequentially laminated, whereby a three-dimensional shaped article is formed, has attracted attention.

In the production of a three-dimensional shaped article in this manner, a composition containing a metal powder that is an assembly of a plurality of metal particles and a solvent is sometimes used. For example, JP-A-2008-184622 discloses a three-dimensional shaped article production apparatus for producing a three-dimensional shaped article by repeatedly performing a process for forming a layer using a metal paste containing a metal powder and a solvent, and irradiating the layer with a laser beam.

However, when the layer formed using the composition containing the metal powder is irradiated with a laser beam, a molten material of the metal particles or the like is likely to be flicked out by energy of the laser beam, and it was difficult to sufficiently increase the dimensional accuracy of the three-dimensional shaped article.

### SUMMARY

The present disclosure has been made for solving the above problem and can be realized as the following application example.

A three-dimensional shaped article producing powder according to an application example of the present disclosure is a three-dimensional shaped article producing powder including a plurality of metal particles, and being used for producing a three-dimensional shaped article by laminating a plurality of layers while joining the metal particles to one another by irradiation with a laser beam, wherein as the metal particles, first metal particles and second metal particles having a composition different from the first metal particles are included, and X1>X2 and κ1<κ2, wherein X1 [mass %] is a content ratio of the first metal particles in the three-dimensional shaped article producing powder, X2 [mass %] is a content ratio of the second metal particles in the three-dimensional shaped article producing powder, κ1[%] is a reflectance of a maximum peak wavelength component of the laser beam at 25° C. with respect to the first metal particles, and κ2 [%] is a reflectance of a maximum peak wavelength component of the laser beam at 25° C. with respect to the second metal particles.

### BRIEF DESCRIPTION OF THE DRAWINGS

FIG. 1 is a cross-sectional view schematically showing a preferred embodiment of a three-dimensional shaped article producing powder.

FIG. 2 is a cross-sectional view schematically showing a state in which the three-dimensional shaped article producing powder shown in FIG. 1 is irradiated with a laser beam.

FIG. 3 is a vertical sectional view schematically showing a layer formation step that is a step in a preferred embodiment of a production method for a three-dimensional shaped article.

FIG. 4 is a vertical sectional view schematically showing a solvent removal step that is a step in a preferred embodiment of a production method for a three-dimensional shaped article.

FIG. 5 is a vertical sectional view schematically showing a joining step that is a step in a preferred embodiment of a production method for a three-dimensional shaped article.

FIG. 6 is a vertical sectional view schematically showing a layer formation step that is a step in a preferred embodiment of a production method for a three-dimensional shaped article.

FIG. 7 is a vertical sectional view schematically showing a solvent removal step that is a step in a preferred embodiment of a production method for a three-dimensional shaped article.

FIG. 8 is a vertical sectional view schematically showing a joining step that is a step in a preferred embodiment of a production method for a three-dimensional shaped article.

FIG. 9 is a vertical sectional view schematically showing a state after performing a step, particularly a layer formation step in a preferred embodiment of a production method for a three-dimensional shaped article a plurality of times.

FIG. 10 is a vertical sectional view schematically showing a three-dimensional shaped article obtained in a preferred embodiment of a production method for a three-dimensional shaped article.

FIG. 11 is a flowchart showing a preferred embodiment of a production method for a three-dimensional shaped article.

FIG. 12 is a vertical sectional view schematically showing a preferred embodiment of a three-dimensional shaped article production apparatus.

### DESCRIPTION OF EXEMPLARY EMBODIMENTS

Hereinafter, preferred embodiments will be described in detail with reference to the accompanying drawings.

### [1] Three-Dimensional Shaped Article Producing Powder

First, a three-dimensional shaped article producing powder of the present disclosure will be described.

FIG. 1 is a cross-sectional view schematically showing a preferred embodiment of a three-dimensional shaped article producing powder, and FIG. 2 is a cross-sectional view schematically showing a state in which the three-dimensional shaped article producing powder shown in FIG. 1 is irradiated with a laser beam.

A three-dimensional shaped article producing powder 2′ includes a plurality of metal particles 21′ and is used for producing a three-dimensional shaped article 10 by laminating a plurality of layers 1 while joining the metal particles 21′ to one another by irradiation with a laser beam L. In the three-dimensional shaped article producing powder 2′, as shown in FIG. 1, first metal particles 21A′ and second metal particles 21B′ are included as the metal particles 21′. The first metal particles 21A′ and the second metal particles 21B′ have mutually different compositions.

The first metal particles 21A′ and the second metal particles 21B′ satisfy the following condition (A) or (B).

(A) The following conditions (A-1) and (A-2) are satisfied.

(A-1) When a content ratio of the first metal particles 21A′ in the three-dimensional shaped article producing powder 2′ is denoted by X1 [mass %] and a content ratio of the second metal particles 21B′ in the three-dimensional shaped article producing powder 2′ is denoted by X2 [mass %], a relationship: X1>X2 is satisfied.

(A-2) When a reflectance of a maximum peak wavelength component of the laser beam L at 25° C. with respect to the first metal particles 21A′ is denoted by κ1 [%] and a reflectance of a maximum peak wavelength component of the laser beam L at 25° C. with respect to the second metal particles 21B′ is denoted by κ2 [%], a relationship: κ1<κ2 is satisfied.

(B) The following conditions (B-1) and (B-2) are satisfied.

(B-1) When a content ratio of the first metal particles 21A′ in the three-dimensional shaped article producing powder 2′ is denoted by X1 [mass %] and a content ratio of the second metal particles 21B′ in the three-dimensional shaped article producing powder 2′ is denoted by X2 [mass %], a relationship: X1>X2 is satisfied.

(B-2) When a thermal conductivity at 25° C. of the first metal particles 21A′ is denoted by λ1 [W/m·K] and a thermal conductivity at 25° C. of the second metal particles 21B′ is denoted by λ2 [W/m·K], a relationship: λ1<λ2 is satisfied.

According to this, the three-dimensional shaped article producing powder 2′ that can be favorably used for producing the three-dimensional shaped article 10 having excellent dimensional accuracy can be provided.

In particular, it is preferred to satisfy both the above conditions (A) and (B).

The reason why the excellent effect as described above is obtained by including the second metal particles 21B′ as a secondary component in addition to the first metal particles 21A′ serving as a primary component in the three-dimensional shaped article producing powder 2′ is considered as follows. That is, as shown in FIG. 2, when the metal particles 21′ is melted at a site irradiated with the laser beam L, the second metal particles 21B′ can efficiently diffuse energy of the laser beam L in an appropriate proportion by reflection or thermal conduction. As a result, excessive thermal expansion or Marangoni convection caused thereby at the site irradiated with the laser beam L, the formation of a molten pool 3′ which is formed by the melting of the metal particles 21′ deeper or larger than necessary, or the like can be effectively prevented. Accordingly, it is considered that a molten material of the metal particles 21′ or the like can be effectively prevented from being flicked out, and as a result, the dimensional accuracy of the three-dimensional shaped article 10 to be finally obtained can be improved.

On the other hand, when the above condition (A) or (B) is not satisfied when the first metal particles are used as the primary component of the three-dimensional shaped article, satisfactory results cannot be obtained.

For example, when the above condition (A) is not satisfied, a problem as described below occurs.

That is, for example, when a three-dimensional shaped article producing powder includes particles corresponding to the first metal particles, that is, metal particles having a relatively low reflectance of a maximum peak wavelength component of a laser beam, but does not include particles corresponding to the second metal particles, that is, metal particles having a relatively high reflectance of a maximum peak wavelength component of a laser beam, a problem as described below occurs. That is, at a site irradiated with a laser beam when producing a three-dimensional shaped article, it becomes difficult to moderately diffuse energy of the laser beam, and a molten material of the metal particles or the like is likely to be flicked out. As a result, the dimensional accuracy of the three-dimensional shaped article to be finally obtained is significantly deteriorated.

Further, when, although a three-dimensional shaped article producing powder includes the first metal particles and the second metal particles, these do not satisfy the magnitude relationship of the content ratio: X1>X2 as described above, a problem as described below occurs. That is, at a site irradiated with a laser beam when producing a three-dimensional shaped article, diffusion of energy of the laser beam excessively proceeds, and a joined portion that is a region in which the metal particles are melted and joined is likely to become excessively large as compared with the region irradiated with the laser beam. As a result, the dimensional accuracy of the three-dimensional shaped article is deteriorated. In addition, energy required for joining the metal particles is increased, and therefore, such a case is not preferred also from the viewpoint of energy saving.

Further, for example, when the above condition (B) is not satisfied, a problem as described below occurs.

That is, for example, when a three-dimensional shaped article producing powder includes particles corresponding to the first metal particles, that is, metal particles having a relatively low thermal conductivity, but does not include particles corresponding to the second metal particles, that is, metal particles having a relatively high thermal conductivity, a problem as described below occurs. That is, at a site irradiated with a laser beam when producing a three-dimensional shaped article, it becomes difficult to moderately diffuse energy of the laser beam, and a molten material of the metal particles or the like is likely to be flicked out. As a result, the dimensional accuracy of the three-dimensional shaped article to be finally obtained is significantly deteriorated.

Further, when, although a three-dimensional shaped article producing powder includes the first metal particles and the second metal particles, these do not satisfy the magnitude relationship of the content ratio: X1>X2 as described above, a problem as described below occurs. That is, at a site irradiated with a laser beam when producing a three-dimensional shaped article, diffusion of energy of the laser beam excessively proceeds, and a joined portion that is a region in which the metal particles are melted and joined is likely to become excessively large as compared with the region irradiated with the laser beam. As a result, the dimensional accuracy of the three-dimensional shaped article is deteriorated. In addition, energy required for joining the metal particles is increased, and therefore, such a case is not preferred also from the viewpoint of energy saving.

In the present disclosure, the values of the reflectances κ1 and κ2 are calculated from a total reflection component including diffuse reflection using V-570 manufactured by JASCO Corporation. A value determined by measurement under the conditions of a bandwidth of 2 nm, a near-infrared bandwidth of 8 nm, a measurement range from 2000 to 250 nm, a data acquisition interval of 2 nm, and a scanning speed of 100 nm/min shall be adopted.

As described above, it is only necessary to satisfy the relationship: X1>X2 between the above X1 and the above X2, however, it is preferred to satisfy a relationship: 3≤X1/X2≤1000.

According to this, the above-mentioned effect is more remarkably exhibited.

Further, when the above condition (A) is satisfied, it is only necessary to satisfy the relationship: κ1<κ2 between the above κ1 and the above κ2, however, it is preferred to satisfy a relationship: 3≤κ2−κ1≤75, and it is more preferred to satisfy a relationship: 10≤κ2−κ1≤69, it is further more preferred to satisfy a relationship: 17≤κ2−κ1≤63.

According to this, the above-mentioned effect is more remarkably exhibited.

Further, when the above condition (B) is satisfied, it is only necessary to satisfy the relationship: λ1<λ2 between the above λ1 and the above λ2, however, it is preferred to satisfy a relationship: 300≤λ2−λ1≤445.

According to this, the above-mentioned effect is more remarkably exhibited.

### [1-1] First Metal Particles

The three-dimensional shaped article producing powder 2′ includes the first metal particles 21A′ as one type of the metal particles 21′.

The shape of the first metal particle 21A′ is not particularly limited, and may be any shape such as a spherical shape, a spindle shape, a needle shape, a cylindrical shape, or a scaly shape, and further, it may be an indefinite shape, but is preferably a spherical shape.

The average particle diameter of the first metal particles 21A′ is preferably 1.0 μm or more and 100 μm or less, more preferably 2.0 μm or more and 4.0 μm or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced. Further, for example, a solvent, a binder, or the like contained in the layer 1 can be efficiently removed, and a constituent material other than the metal particles 21′ can be more effectively prevented from undesirably remaining in the final three-dimensional shaped article 10. Further, when the three-dimensional shaped article producing powder 2′ is used for preparing the below-mentioned three-dimensional shaped article producing composition 1′, it becomes easy to adjust the viscosity of the three-dimensional shaped article producing composition 1′ to a more favorable value.

Note that in the present disclosure, the average particle diameter refers to a volume-based average particle diameter (d50), and is measured using, for example, Microtrac MT3200II (manufactured by MicrotracBEL Corporation) or the like. Particles in a methanol liquid are irradiated with light, and diffracted scattered light to be generated is measured using detectors disposed at the front, lateral, and rear sides in the liquid. By utilizing the measurement values and assuming that the particles originally having an indefinite shape have a spherical shape, a cumulative curve is determined by taking the total volume of the assembly of the particles converted into spheres having a volume equal to that of the particles as 100%. A point at which a cumulative value at that time becomes 50% is determined as the 50% average particle diameter (d50).

The content ratio X1 of the first metal particles 21A′ in the three-dimensional shaped article producing powder 2′ is preferably 50 mass % or more and 99 mass % or less, more preferably 70 mass % or more and 95 mass % or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced. Further, the property of the constituent material of the first metal particles 21A′ can be favorably reflected on the property of the three-dimensional shaped article 10 to be produced, and it becomes easy to control the property of the three-dimensional shaped article 10.

The reflectance κ1 of the maximum peak wavelength component of the laser beam L at 25° C. with respect to the first metal particles 21A′ is preferably 15% or more and 65% or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

The thermal conductivity λ1 at 25° C. of the first metal particles 21A′ is preferably 5 W/m·K or more and 50 W/m·K or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

The melting point of the first metal particles 21A′ is preferably 1100° C. or higher and 2000° C. or lower, more preferably 1200° C. or higher and 1800° C. or lower, further more preferably 1300° C. or higher and 1600° C. or lower.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

Examples of the constituent material of the first metal particles 21A′ include magnesium, iron, gold, silver copper, cobalt, titanium, chromium, nickel aluminum, and an alloy containing at least one type of these metals. Examples of the alloy include a maraging steel, a stainless steel, cobalt-chromium-molybdenum, a titanium alloy, a nickel-based alloy, and an aluminum alloy.

According to this, the relationship between the first metal particles 21A′ and the second metal particles 21B′ as described above can be easily realized, and also the range of choice of the constituent material of the second metal particles 21B′ can be expanded. Further, it is advantageous also in terms of making the mechanical strength, corrosion resistance, aesthetic property, or the like of the three-dimensional shaped article 10 more excellent.

The three-dimensional shaped article producing powder 2′ may include the first metal particles 21A′ having a different condition such as a particle diameter, a shape, or a composition. Even in such a case, the respective first metal particles 21A′ satisfy the relationship: κ1≤κ2 or λ1<λ2 with the respective second metal particles 21B′ included in the three-dimensional shaped article producing powder 2′.

### [1-2] Second Metal Particles

The three-dimensional shaped article producing powder 2′ includes, as one type of the metal particles 21′, the second metal particles 21B′ having a composition different from the first metal particles 21A′ together with the first metal particles 21A′.

The shape of the second metal particles 21B′ is not particularly limited, and may be any shape such as a spherical shape, a spindle shape, a needle shape, a cylindrical shape, or a scaly shape, and further, it may be an indefinite shape, but is preferably a spherical shape.

The average particle diameter of the second metal particles 21B′ is preferably 0.1 μm or more and 10 μm or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced. Further, for example, a solvent, a binder, or the like contained in the layer 1 can be efficiently removed, and a constituent material other than the metal particles 21′ can be more effectively prevented from undesirably remaining in the final three-dimensional shaped article 10. Further, when the three-dimensional shaped article producing powder 2′ is used for preparing the below-mentioned three-dimensional shaped article producing composition 1′, it becomes easy to adjust the viscosity of the three-dimensional shaped article producing composition 1′ to a more favorable value.

The content ratio X2 of the second metal particles 21B′ in the three-dimensional shaped article producing powder 2′ is preferably 1 mass % or more and 50 mass % or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced. Further, the content ratio X1 of the first metal particles 21A′ in the three-dimensional shaped article producing powder 2′ can be made sufficiently high, and the property of the constituent material of the first metal particles 21A′ can be favorably reflected on the property of the three-dimensional shaped article 10 to be produced, and it becomes easy to control the property of the three-dimensional shaped article 10.

The reflectance κ2 of the maximum peak wavelength component of the laser beam L at 25° C. with respect to the second metal particles 21B′ is preferably 68% or more and 90% or less, more preferably 70% or more and 89% or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

The thermal conductivity λ2 at 25° C. of the second metal particles 21B′ is preferably 350 W/m·K or more and 450 W/m·K or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

The melting point of the second metal particles 21B′ is preferably 500° C. or higher and 1400° C. or lower, more preferably 700° C. or higher and 1300° C. or lower, further more preferably 900° C. or higher and 1200° C. or lower.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

Examples of the constituent material of the second metal particles 21B′ include magnesium, iron, gold, silver copper, cobalt, titanium, chromium, nickel, aluminum, and an alloy containing at least one type of these metals. Examples of the alloy include a maraging steel, a stainless steel, cobalt-chromium-molybdenum, a titanium alloy, a nickel-based alloy, and an aluminum alloy.

According to this, the relationship between the first metal particles 21A′ and the second metal particles 21B′ as described above can be easily realized, and also the range of choice of the constituent material of the first metal particles 21A′ can be expanded.

The three-dimensional shaped article producing powder 2′ may include the second metal particles 21B′ having a different condition such as a particle diameter, a shape, or a composition.

Even in such a case, the respective second metal particles 21B′ satisfy the relationship: κ1<κ2 or λ1<λ2 with the respective first metal particles 21A′ included in the three-dimensional shaped article producing powder 2′.

When the melting point of the first metal particles 21A′ is denoted by Tm1 [° C.] and the melting point of the second metal particles 21B′ is denoted by Tm2 [° C.], it is preferred to satisfy a relationship: Tm1>Tm2, it is more preferred to satisfy a relationship: 100≤Tm1−Tm2≤600, and it is further more preferred to satisfy a relationship: 200≤Tm1−Tm2≤400.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

When the true density of the first metal particles 21A′ is denoted by ρ1 [g/cm³] and the true density of the second metal particles 21B′ is denoted by ρ2 [g/cm³], it is preferred to satisfy a relationship: −2.0≤ρ1−ρ2≤2.0, it is more preferred to satisfy relationship: −1.5≤ρ1−ρ2≤1.5, and it is further more preferred to satisfy a relationship: −1.0≤ρ1−ρ2≤1.0.

According to this, an undesirable variation in the composition in the three-dimensional shaped article producing powder 2′ or the three-dimensional shaped article producing composition 1′ produced using the three-dimensional shaped article producing powder 2′, or the layer 1 when producing the three-dimensional shaped article 10 can be more effectively prevented, and the reliability of the three-dimensional shaped article to be produced can be made more excellent.

The three-dimensional shaped article producing powder 2′ may include a particle other than the first metal particles 21A′ and the second metal particles 21B′. Hereinafter, such a particle is referred to as a third particle. The three-dimensional shaped article producing powder 2′ may include a plurality of third particles.

However, the content ratio of the third particles included in the three-dimensional shaped article producing powder 2′ is preferably 10.0 mass % or less, more preferably 5.0 mass % or less, further more preferably 1.0 mass % or less.

According to this, the effect of the present disclosure described above is more remarkably exhibited.

### [2] Three Dimensional Shaped Article Producing Composition

Next, the three-dimensional shaped article producing composition of the present disclosure will be described.

The three-dimensional shaped article producing composition 1′ is used for forming a layer 1 of the three-dimensional shaped article 10, in which a plurality of layers 1 are laminated, by an ejection method. The three-dimensional shaped article producing composition 1′ contains the three-dimensional shaped article producing powder 2′, a binder, and a solvent.

According to this, the three-dimensional shaped article producing composition 1′ that can be favorably used for producing the three-dimensional shaped article 10 having excellent dimensional accuracy can be provided.

In the present disclosure, the solvent is a liquid capable of dispersing the metal particles, that is, a dispersion medium. Then, the solvent is preferably a volatile liquid, that is, a substance that has a predetermined boiling point by itself and is not substantially decomposed at the boiling point.

### [2-1] Three-Dimensional Shaped Article Producing Powder

The content ratio of the three-dimensional shaped article producing powder 2′ in the three-dimensional shaped article producing composition 1′ is preferably 70 mass % or more and 90 mass % or less, more preferably 80 mass % or more and 90 mass % or less.

According to this, the ejection of the three-dimensional shaped article producing composition 1′ can be more stably performed over a long period of time. Further, the content ratio of a component to be removed in the production process for the three-dimensional shaped article 10 can be prevented from increasing more than necessary, and therefore, a time and energy required for removing the component can be saved, and therefore, it is advantageous from the viewpoint of improvement of the productivity of the three-dimensional shaped article 10, reduction of the production cost of the three-dimensional shaped article 10, energy saving, or the like.

### [2-2] Binder

The binder has a function of temporarily binding the metal particles 21′ to one another in a state where the solvent has been removed.

By including the binder in the three-dimensional shaped article producing composition 1′, for example, the stability of the shape of the layer 1 to be formed using the three-dimensional shaped article producing composition 1′ can be enhanced, and undesirable deformation of the layer 1 can be effectively prevented.

Further, undesirable scattering of the metal particles 21′ or a molten material thereof when being irradiated with the laser beam L in the joining step can be effectively prevented. According to this, the occurrence of undesirable irregularities at the surface of the layer 1 in which the below-mentioned joined portion 3 is formed can be effectively prevented.

As a result, the dimensional accuracy of the three-dimensional shaped article 10 can be improved.

The binder may be any as long as it has a function of temporarily fixing the metal particles 21′ in the three-dimensional shaped article producing composition 1′ before being subjected to the joining step, and for example, various types of resin materials such as a thermoplastic resin and a curable resin, and the like can be used.

When a curable resin is contained, a curing reaction of the curable resin may be performed at a timing after ejection of the three-dimensional shaped article producing composition 1′ and before the below-mentioned joining step.

Specific examples of the binder include an acrylic resin, an epoxy resin, a silicone resin, polyvinyl alcohol, polylactic acid, polyamide, polyphenylene sulfide, an alginate, pectin, methylcellulose, nanocellulose, and a cyclic cellulose derivative such as cyclodextrin, and one type or a combination of two or more types selected from these can be used.

The content ratio of the binder in the three-dimensional shaped article producing composition 1′ is preferably 0.1 mass % or more and 10 mass % or less.

According to this, the function of the binder as described above is more effectively exhibited, and also the binder or a decomposed material thereof or a denatured material thereof can be more effectively prevented from remaining in the final three-dimensional shaped article 10.

### [2-3] Solvent

The three-dimensional shaped article producing composition 1′ contains a solvent having a function of dispersing the metal particles 21′.

According to this, for example, the ejection of the three-dimensional shaped article producing composition 1′ by a dispenser or the like can be more stably performed.

Examples of the solvent constituting the three-dimensional shaped article producing composition 1′ include water, volatile liquids including ethers such as ethylene glycol monomethyl ether, ethylene glycol monoethyl ether, propylene glycol monomethyl ether, propylene glycol monoethyl ether, diethyl diglycol, diethylene glycol monobutyl ether acetate, and diethylene glycol monoethyl ether; acetate esters such as ethyl acetate, n-propyl acetate, iso-propyl acetate, n-butyl acetate, and iso-butyl acetate; carbitols such as carbitol and an ester compound thereof; cellosolves such as cellosolve and an ester compound thereof; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols including monohydric alcohols such as ethanol, propanol, butanol, and 2-ethyl-1-hexanol, polyhydric alcohols such as ethylene glycol, propylene glycol, butanediol, and glycerin, and the like; sulfoxide-based solvents such as dimethyl sulfoxide and diethyl sulfoxide; pyridine-based solvents such as pyridine, picoline, and 2,6-lutidine; and the like, and ionic liquids including a tetraalkylammonium acetate such as tetraalkylammonium acetate, and the like, and one type or a combination of two or more types selected from these can be used.

Among these, the solvent preferably contains water.

According to this, as compared with a case where a solvent containing no water, particularly, an organic solvent having a relatively high boiling point is used, removal of the solvent from the layer 1 can be easily performed when producing the three-dimensional shaped article 10, and therefore, it is advantageous in terms of increasing the productivity of the three-dimensional shaped article 10. Further, undesirable deformation involved in rapid volatilization, for example, bumping or the like of the solvent in the joining step described in detail later can be more effectively prevented, and the dimensional accuracy of the three-dimensional shaped article 10 can be further improved.

The proportion of water in the entire solvent constituting the three-dimensional shaped article producing composition 1′ is preferably 50 mass % or more, more preferably 80 mass % or more, further more preferably 90 mass % or more.

According to this, the effect described above is more remarkably exhibited.

The content ratio of the solvent in the three-dimensional shaped article producing composition 1′ is preferably 10 mass % or more and 30 mass % or less.

According to this, for example, the ejection of the three-dimensional shaped article producing composition 1′ can be more stably performed over a longer period of time.

### [2-4] Another Component

The three-dimensional shaped article producing composition 1′ may contain a component other than the above-mentioned components. Examples of such a component include a polymerization initiator, a dispersant, a surfactant, a thickener, an anti-aggregation agent, a defoaming agent, a leveling agent, a dye, a polymerization inhibitor, a polymerization accelerator, a permeation accelerator, a humectant, a fixing agent, an antifungal agent, a preservative, an antioxidant, a UV absorber, a chelating agent, and a pH adjusting agent.

However, the sum of the content ratios of these components in the three-dimensional shaped article producing composition 1′ is preferably 5 mass % or less, more preferably 3 mass % or less.

The three-dimensional shaped article producing composition 1′ is preferably ejected by a dispenser when forming the layer 1.

According to this, the ejection of the three-dimensional shaped article producing composition 1′ can be more stably performed, and also an undesirable variation in the thickness of the layer 1 to be formed can be more effectively suppressed.

### [3] Production Method for Three-Dimensional Shaped Article

Next, a production method for a three-dimensional shaped article using the above-mentioned three-dimensional shaped article producing composition of the present disclosure will be described.

FIGS. 3 to 9 are vertical sectional views schematically showing steps in a preferred embodiment of the production method for a three-dimensional shaped article. FIG. 10 is a vertical sectional view schematically showing a three-dimensional shaped article obtained in a preferred embodiment of the production method for a three-dimensional shaped article. FIG. 11 is a flowchart showing a preferred embodiment of the production method for a three-dimensional shaped article.

The production method for the three-dimensional shaped article 10 of this embodiment is a method for producing the three-dimensional shaped article 10, in which a plurality of layers 1 are laminated, by forming the layer 1 from the three-dimensional shaped article producing composition 1′ by an ejection method.

More specifically, the production method for the three-dimensional shaped article 10 of this embodiment includes a layer formation step of forming the layer 1 using the above-mentioned three-dimensional shaped article producing composition 1′ of the present disclosure as shown in FIGS. 3 and 6, a solvent removal step of removing the solvent contained in the layer 1 as shown in FIGS. 4 and 7, and a joining step of joining the metal particles 21′ included in the layer 1 to one another by irradiating the layer 1 with the laser beam L, thereby forming the joined portion 3 as shown in FIGS. 5 and 8. Then, as shown in FIG. 9, a series of steps including the layer formation step, the solvent removal step, and the joining step is repeatedly performed.

According to this, the three-dimensional shaped article 10 having high dimensional accuracy can be stably produced.

Hereinafter, the respective steps will be described in detail.

### [3-1] Layer Formation Step

In the layer formation step, for example, the layer 1 is formed by ejecting the three-dimensional shaped article producing composition 1′ from a composition ejection unit M3 on a plane M410 of a stage M41.

A method for ejecting the three-dimensional shaped article producing composition 1′ is not particularly limited, but it is preferably ejected by a dispenser.

In this manner, by using a dispenser, the three-dimensional shaped article producing composition 1′ that satisfies the conditions of the composition and the viscosity described above can be more stably ejected, and a favorable layer 1 can be formed. Further, as compared with a case where a method other than the dispenser is used, an undesirably variation in the thickness of the layer 1 can be effectively suppressed, and it is advantageous also in terms of improving the dimensional accuracy of the three-dimensional shaped article 10 to be produced. In addition, the layer 1 having a relatively large thickness can be easily formed, and it is advantageous also in terms of further improving the productivity of the three-dimensional shaped article 10.

In this step, the three-dimensional shaped article producing composition 1′ may be ejected in the form of a continuous body or as a plurality of liquid droplets, however, in the configuration shown in the drawing, a case where it is ejected as a plurality of liquid droplets is shown.

In the production of the three-dimensional shaped article 10, as the three-dimensional shaped article producing composition 1′, multiple types of compositions may be used.

### [3-2] Solvent Removal Step

In the solvent removal step, the solvent contained in the layer 1 is removed.

According to this, the fluidity of the layer 1 is decreased, and the stability of the shape of the layer 1 is improved. In addition, by performing this step, undesirable deformation involved in rapid volatilization, for example, bumping or the like of the solvent in the subsequent joining step can be effectively prevented. Accordingly, the three-dimensional shaped article 10 having excellent dimensional accuracy can be more reliably obtained, and the reliability of the three-dimensional shaped article 10 can be further improved, and also the productivity of the three-dimensional shaped article 10 can be further improved.

As a method for removing the solvent, natural drying may be adopted, however, in the configuration shown in the drawing, a solvent removal unit M9 is used. According to this, the productivity of the three-dimensional shaped article 10 can be further enhanced.

As a specific method for removing the solvent using the solvent removal unit M9, for example, heating of the layer 1, irradiation of the layer 1 with an infrared ray, placement of the layer 1 under reduced pressure, supply of a gas with a low liquid component content ratio such as dry air, etc. are exemplified. Further, two or more methods selected from these may be performed in combination. When a method for supplying a gas with a low liquid component content ratio is adopted, as the gas, a gas with a relative humidity of 30% or less can be favorably used.

This step may be, for example, performed concurrently with the above-mentioned layer formation step. More specifically, for example, before the layer 1 is completed by ejecting the three-dimensional shaped article producing composition 1′, a treatment for removing the solvent from the ejected three-dimensional shaped article producing composition 1′ may be performed.

Further, in this step, it is not necessary to completely remove the solvent contained in the layer 1.

The content ratio of the solvent in the layer 1 after this step is preferably 0.1 mass % or more and 25 mass % or less, more preferably 0.5 mass % or more and 20 mass % or less.

According to this, undesirable deformation involved in rapid volatilization, for example, bumping or the like of the solvent in the subsequent step can be effectively prevented, and therefore, the three-dimensional shaped article 10 having excellent dimensional accuracy can be more reliably obtained, and the reliability of the three-dimensional shaped article 10 can be further improved, and also the productivity of the three-dimensional shaped article 10 can be further improved.

### [3-3] Joining Step

In the joining step, the layer 1 is irradiated with the laser beam L by a laser beam irradiation unit M6, and at least the surfaces of the metal particles 21′ included in the layer 1 are heated and melted. More specifically, in each layer 1, a portion to become an entity portion of the three-dimensional shaped article 10 is selectively irradiated by allowing the laser beam L to scan the portion.

According to this, the metal particles 21′ included in the three-dimensional shaped article producing composition 1′ are joined to one another, thereby forming the joined portion 3. By forming the joined portion 3 in this manner, undesirable migration of the metal particles 21′ thereafter is prevented, and the dimensional accuracy of the three-dimensional shaped article 10 can be improved. Further, in the joined portion 3 formed in this manner, generally, the metal particles 21′ are joined to one another with a sufficient joining strength. Further, in this step, when the layer 1 in which the joined portion 3 is formed is present at the lower side of the layer 1 to be irradiated with the laser beam L, the joined portion 3 of the layer 1 at the lower side and the newly formed joined portion 3 are generally joined to each other. As a result, the mechanical strength of the three-dimensional shaped article 10 to be finally obtained can be improved.

Further, by using the laser beam L, energy can be applied at a desired site with high selectivity, and therefore, it is advantageous in terms of improving the productivity of the three-dimensional shaped article 10. Further, the energy efficiency can be improved, and therefore, it is advantageous also in terms of energy saving.

The three-dimensional shaped article producing composition 1′ includes the first metal particles 21A′ and the second metal particles 21B′ that satisfy the relationship as described above as the metal particles 21′, and therefore, a molten material of the metal particles 21′ or the like can be effectively prevented from being flicked out when being irradiated with the laser beam L, and the dimensional accuracy of the three-dimensional shaped article 10 to be finally obtained can be improved.

Further, in this step, by the irradiation with the laser beam L, the metal particles 21′ are joined, and also unnecessary components other than the metal particles 21′ can be removed. For example, the binder, the remaining solvent, and the like can be removed, and these components can be effectively prevented from remaining in the joined portion 3 to be formed.

As the form of the joining, for example, sintering, melt-solidification, or the like is exemplified.

Examples of the laser that can be used in this step include solid lasers such as a ruby laser, a YAG laser, a Nd:YAG laser, a titanium sapphire laser, and a semiconductor laser; liquid lasers such as a dye laser; gas lasers including neutral atom lasers such as a helium neon laser, ion lasers such as an argon ion laser, molecular lasers such as a carbon dioxide gas laser and a nitrogen laser, an excimer laser, metal-vapor lasers such as a helium cadmium laser, and the like; a free electron laser; chemical lasers such as an oxygen-iodine chemical laser and a hydrogen fluoride laser; and a fiber laser.

Although depending on the composition of the first metal particles 21A′ or the second metal particles 21B′, or the like, the maximum peak wavelength of the laser beam L to be irradiated in this step is preferably 300 nm or more and 1300 nm or less, more preferably 500 nm or more and 1250 nm or less, further more preferably 700 nm or more and 1200 nm or less.

In particular, it is particularly preferred that all the maximum peak wavelength of the laser beam L, the reflectance of the maximum peak wavelength component of the laser beam L at 25° C. with respect to the first metal particles 21A′, and the reflectance of the maximum peak wavelength component of the laser beam L at 25° C. with respect to the second metal particles 21B′ satisfy the above-mentioned conditions. That is, it is preferred that the maximum peak wavelength of the laser beam L is 300 nm or more and 1300 nm or less, the reflectance of the maximum peak wavelength component of the laser beam L at 25° C. with respect to the first metal particles 21A′ is 15% or more and 65% or less, and the reflectance of the maximum peak wavelength component of the laser beam L at 25° C. with respect to the second metal particles 21B′ is 68% or more and 90% or less.

According to this, the balance between melting of the metal particles 21′ in the vicinity of a site irradiated with the laser beam L and diffusion of energy of the laser beam L can be made more favorable, and the dimensional accuracy of the three-dimensional shaped article 10 to be produced can be further enhanced.

The beam diameter of the laser beam L is not particularly limited, but is preferably 120 μm or more and 300 μm or less, more preferably 150 μm or more and 250 μm or less, further more preferably 180 μm or more and 200 μm or less.

According to this, the dimensional accuracy of the three-dimensional shaped article 10 to be produced can be further enhanced.

This step may be performed, for example, in an inert atmosphere of nitrogen gas, helium gas, neon gas, argon gas, or the like, or may be performed in a reduced pressure atmosphere. According to this, an undesirable chemical reaction of the constituent material of the metal particles 21′ can be effectively prevented.

Further, this step may be performed in a reactive gas atmosphere of oxygen gas or the like. According to this, the three-dimensional shaped article 10 constituted by a material having a composition different from the composition of the metal particles 21′ included in the three-dimensional shaped article producing composition 1′ can be obtained.

The atmosphere in which this step is performed is appropriately determined according to, for example, conditions such as the composition of the three-dimensional shaped article producing composition 1′ or the particle diameter of the metal particle 21′.

The thickness of the layer 1 including the joined portion 3 is not particularly limited, but is preferably 5 μm or more and 300 μm or less, more preferably 10 μm or more and 200 μm or less.

According to this, the dimensional accuracy of the three-dimensional shaped article 10 can be further improved while improving the productivity of the three-dimensional shaped article 10.

Note that, for example, the conditions for irradiation with the laser beam L such as the type of the laser beam L, the irradiation intensity, or the like may be adjusted so as to be different at each site of the layer 1.

### [3-4] Completion of Three-Dimensional Shaped Article

Thereafter, a series of steps including the layer formation step, the solvent removal step, and the joining step described above is repeatedly performed, whereby a laminate 50 in which a plurality of layers 1 are laminated is obtained as shown in FIG. 9. Then, the laminate 50 includes the three-dimensional shaped article 10 including the joined portion 3 provided over the plurality of layers 1.

Thereafter, as shown in FIG. 10, by removing a portion other than the joined portion 3 in each layer 1 from the laminate 50, the three-dimensional shaped article 10 is taken out.

The production method for the three-dimensional shaped article 10 as described above is summarized in a flowchart as shown in FIG. 11.

As shown in FIG. 11, in the production of the three-dimensional shaped article 10, a series of steps including the layer formation step, the solvent removal step, and the joining step is repeatedly performed a predetermined number of times, whereby the laminate 50 in which the plurality of layers 1 are laminated is obtained.

That is, it is determined whether a new layer 1 should be formed on the already formed layer 1, and when there is a layer 1 that should be formed, a new layer 1 is formed, and when there is no layer 1 that should be formed, the laminate 50 is subjected to an unnecessary portion removal step of removing a portion other than the joined portion 3 in each layer 1 as a post-treatment, whereby the target three-dimensional shaped article 10 is obtained.

Note that in the configuration shown in the drawings, for facilitating understanding, the description has been made under the assumption that the respective steps described above are sequentially performed, however, different steps may be concurrently performed at respective sites in a space on the stage that is the shaping region. For example, while forming the layer 1, the solvent removal step or the joining step may be performed at another site of the layer 1 before completion of the formation of the layer 1.

### [4] Three-Dimensional Shaped Article Production Apparatus

Next, a three-dimensional shaped article production apparatus will be described.

FIG. 12 is a cross-sectional view schematically showing a preferred embodiment of a three-dimensional shaped article production apparatus.

A three-dimensional shaped article production apparatus M100 is an apparatus to be used for producing the three-dimensional shaped article 10 by performing the formation of the layer 1 a plurality of times, and includes a composition ejection unit M3 as a nozzle for ejecting the three-dimensional shaped article producing composition 1′, and a laser beam irradiation unit M6 that irradiates the laser beam L onto the layer 1 formed by ejecting the three-dimensional shaped article producing composition 1′ by the composition ejection unit M3, and produces the three-dimensional shaped article 10 by laminating the layers 1.

More specifically, the three-dimensional shaped article production apparatus M100 includes a controller M2, the composition ejection unit M3 that includes a nozzle capable of ejecting the three-dimensional shaped article producing composition 1′ in a predetermined pattern, a solvent removal unit M9 for removing at least a portion of the solvent from the layer 1 formed from the three-dimensional shaped article producing composition 1′ ejected from the composition ejection unit M3, and the laser beam irradiation unit M6 that irradiates the laser beam L onto the layer 1 from which at least a portion of the solvent has been removed.

According to this, the effect of the three-dimensional shaped article producing composition 1′ of the present disclosure as described above can be more favorably exhibited.

The controller M2 includes a computer M21 and a drive controller M22.

The computer M21 is a general desktop computer or the like configured to include a CPU, a memory, and the like therein. The computer M21 generates data as model data from the shape of the three-dimensional shaped article 10 and outputs sectional data, that is, slice data obtained by slicing the data into several parallel layers of thin sectional bodies to the drive controller M22.

The drive controller M22 included in the controller M2 functions as a control unit that drives each of the composition ejection unit M3, a layer formation portion M4, the solvent removal unit M9, the laser beam irradiation unit M6, and the like. Specifically, the drive controller M22 controls, for example, driving of the composition ejection unit M3, for example, moving thereof on an X-Y plane or the like, ejection of the three-dimensional shaped article producing composition 1′ by the composition ejection unit M3, descending of the stage M41 movable in the Z direction in FIG. 12 and the descent amount thereof, driving of the solvent removal unit M9, the irradiation pattern or the irradiation or scanning speed of the laser beam L by the laser beam irradiation unit M6, or the like.

To the composition ejection unit M3, a pipe M8 from a composition storage portion M7 in which the three-dimensional shaped article producing composition 1′ is stored and retained is coupled. In the composition storage portion M7, the three-dimensional shaped article producing composition 1′ is stored and ejected from the composition ejection unit M3 by the control of the drive controller M22.

The composition ejection unit M3 can move along a guide M5 independently in each of the X direction and the Y direction in FIG. 12.

The layer formation portion M4 includes the stage M41 that is supplied with the three-dimensional shaped article producing composition 1′ ejected from the composition ejection unit M3 and that supports the layer 1 formed using the three-dimensional shaped article producing composition 1′ , and a frame M45 surrounding the stage M41.

The stage M41 sequentially descends by a predetermined amount according to a command from the drive controller M22 when a new layer 1 is formed on the previously formed layer 1.

In the stage M41, at least a portion to which the three-dimensional shaped article producing composition 1′ is applied of the upper face thereof becomes a flat plane M410. According to this, the layer 1 with high thickness uniformity can be easily and reliably formed.

The stage M41 is preferably constituted by a material with a high strength. Examples of the constituent material of the stage M41 include various types of metal materials such as a stainless steel.

Further, the plane M410 of the stage M41 may be subjected to a surface treatment. According to this, for example, the constituent material of the three-dimensional shaped article producing composition 1′ or the like is more effectively prevented from firmly adhering to the stage M41, or the durability of the stage M41 is improved, and thus, stable production of the three-dimensional shaped article 10 over a long period of time can be achieved. Examples of the material to be used in the surface treatment of the plane M410 of the stage M41 include fluorine-based resins such as polytetrafluoroethylene.

The composition ejection unit M3 is configured to move according to the command from the drive controller M22 and eject the three-dimensional shaped article producing composition 1′ at a desired site on the stage M41.

The composition ejection unit M3 is configured to eject the three-dimensional shaped article producing composition 1′.

As the composition ejection unit M3, for example, an inkjet head, various types of dispensers, etc. are exemplified, however, it is preferably a dispenser.

By using the dispenser in this manner, the three-dimensional shaped article producing composition 1′ that satisfies the conditions of the composition and the viscosity described above can be more stably ejected, and a favorable layer 1 can be formed. Further, as compared with a case where a method other than the dispenser is used, an undesirably variation in the thickness of the layer 1 can be effectively suppressed, and it is advantageous also in terms of improving the dimensional accuracy of the three-dimensional shaped article 10 to be produced. In addition, the layer 1 having a relatively large thickness can be easily formed, and it is advantageous also in terms of further improving the productivity of the three-dimensional shaped article 10.

The nozzle diameter that is the size of an ejection portion of the composition ejection unit M3 is not particularly limited, but is preferably 10 μm or more and 100 μm or less.

According to this, the productivity of the three-dimensional shaped article 10 can be further improved while further improving the dimensional accuracy of the three-dimensional shaped article 10.

The solvent removal unit M9 has a function of removing at least a portion of the solvent contained in the layer 1 formed from the three-dimensional shaped article producing composition 1′ ejected by the composition ejection unit M3.

As the solvent removal unit M9, for example, a line heater or a heating roller for heating the layer 1, an infrared ray irradiation unit that irradiates an infrared ray onto the layer 1, a gas supply unit that supplies a gas having a low liquid component content ratio such as dry air, etc. are exemplified, and it may be configured to combine two or more types selected from these.

When the solvent removal unit M9 is configured to remove the solvent by heating the layer 1, in particular, when it is configured to remove the solvent by coming in contact with the layer 1, due to the excellent thermal conduction property of the second metal particles 21B′, heat can be efficiently transmitted to the entire layer 1, and the removal efficiency of the solvent from the layer 1 can be further enhanced. In addition, an undesirable variation in the residual amount of the solvent at respective sites of the layer 1 after the solvent removal step can be suppressed.

The laser beam irradiation unit M6 has a function of irradiating the laser beam L for joining the metal particles 21′ contained in the layer 1 formed from the three-dimensional shaped article producing composition 1′ ejected by the composition ejection unit M3, particularly, in this embodiment, the layer 1 from which at least a portion of the solvent has been removed by the solvent removal unit M9.

According to this, the metal particles 21′ contained in the layer 1 are joined to one another, whereby the joined portion 3 can be formed. In particular, by allowing the laser beam L to scan the layer 1 containing the metal particles 21′, energy can be selectively applied at a desired site of the layer 1, and energy efficiency in the formation of the joined portion 3 can be further improved. According to this, joining of the metal particles 21′ or the removal of the binder or the like can be more efficiency performed, and the productivity of the three-dimensional shaped article 10 can be further improved. In addition, the energy efficiency can be improved, and therefore, it is advantageous also from the viewpoint of energy saving.

In the present disclosure, the production of the three-dimensional shaped article 10 may be performed in a chamber in which the composition of an atmosphere or the like is controlled. According to this, for example, the joining step can be performed in an inert gas, and undesirable denaturation of the metal particles 21′ or the like can be more effectively prevented. Further, for example, by performing the joining step in an atmosphere containing a reactive gas, the three-dimensional shaped article 10 constituted by a material having a composition different from the composition of the metal particles 21′ to be used as the raw material can be favorably produced.

### [5] Three-Dimensional Shaped Article

A three-dimensional shaped article according to the present disclosure can be produced using the three-dimensional shaped article producing composition of the present disclosure as described above. In particular, the production can be favorably performed by applying the production method for a three-dimensional shaped article, and the three-dimensional shaped article production apparatus as describe above.

According to this, the three-dimensional shaped article to be obtained has high dimensional accuracy and excellent reliability.

The use of the three-dimensional shaped article is not particularly limited, but examples thereof include appreciation articles and exhibits such as watch cases, eyeglass frames, medals, pendant heads, other accessories, tableware, dolls and figures; medical devices such as implants, stents, and artificial bones; bolts, nuts, screws, arms, rings, pipes, and other parts of various types of industrial products.

Further, the three-dimensional shaped article may be applied to any of a prototype, a mass-produced product, and a custom-made product.

Hereinabove, preferred embodiments of the present disclosure are described, however, the present disclosure is not limited thereto.

For example, in the three-dimensional shaped article production apparatus, the configuration of each portion can be replaced with an arbitrary configuration exhibiting a similar function, and further, an arbitrary configuration can also be added.

For example, in the above-mentioned embodiments, the configuration in which the stage moves up and down has been described, however, the apparatus may be configured such that the stage does not move up and down, but a composition supply unit moves up and down.

Further, in the above-mentioned embodiments, the configuration in which the irradiation site with the laser beam of the layer is changed by moving the laser beam irradiation unit on the X-Y plane is illustrated, however, the laser beam irradiation unit may be configured not to move on the X-Y plane. More specifically, for example, the laser beam irradiation unit may be a galvo laser including a laser beam irradiation portion, a plurality of mirrors for positioning a laser beam from the laser beam irradiation portion, and a lens for converging the laser beam. According to this, the laser beam can be allowed to scan at a high speed in a wide range.

Further, in the above-mentioned embodiments, a case where the layer is directly formed at the surface of the stage is representatively described, however, for example, a shaping plate is placed on the stage, and a three-dimensional shaped article may be produced by laminating layers on the shaping plate. In such a case, in the production process for a three-dimensional shaped article, the shaping plate and the metal particles constituting the lowermost layer are joined, and thereafter, the shaping plate may be removed from the target three-dimensional shaped article in a post-treatment. According to this, for example, occurrence of a warpage of the layer in the process for laminating a plurality of layers can be more effectively prevented, and the dimensional accuracy of the three-dimensional shaped article to be finally obtained can be further improved.

Further, in the above-mentioned embodiments, a case where the joined portion is formed in all the layers is representatively described, however, a laminate obtained by laminating a plurality of layers may include, for example, a layer that does not include the joined portion. Further, at a contact face with the stage, a layer in which an entity portion is not formed is formed, and the layer may be allowed to function as a sacrifice layer.

Further, in the production method for a three-dimensional shaped article, a pre-treatment step, an intermediate-treatment step, or a post-treatment step may be performed as needed.

As the pre-treatment step, for example, a stage cleaning step, etc. are exemplified.

As the post-treatment step, for example, a washing step, a shape adjustment step in which deburring, polishing, or the like is performed, a coloring step, a coating layer formation step, a heat treatment step for improving the joining strength between the metal particles, etc. are exemplified.

Further, in the above-mentioned embodiments, a case where with respect to the layer, a region to become an entity portion of a three-dimensional shaped article and the other region are produced using the same composition is described, however, for example, a region to be removed in the unnecessary portion removal step and a region to become an entity portion of a three-dimensional shaped article may be formed using different compositions.

Further, in the above-mentioned embodiments, a case where the composition in which the three-dimensional shaped article producing powder is mixed with another component such as a solvent is used for the production of a three-dimensional shaped article is representatively described, however, the three-dimensional shaped article producing powder may be used for the production of a three-dimensional shaped article, for example, as a powder without being mixed with another component.

Further, the three-dimensional shaped article producing composition of the present disclosure need only be a composition to be used for producing a three-dimensional shaped article by laminating a plurality of layers, and may be applied to a production method other than the production method for a three-dimensional shaped article as described above or an apparatus other than the three-dimensional shaped article production apparatus as described above.

Examples

Hereinafter, the present disclosure will be described in more detail with reference to specific Examples, however, the present disclosure is not limited only to these Examples. Note that in the following description, a treatment for which a temperature condition is not particularly shown was performed at 25° C. Further, also with respect to various measurement conditions, when a temperature condition is not particularly shown, the numerical values are those at 25° C.

### [6] Production of Three-Dimensional Shaped Article Producing Powder

### EXAMPLE A1

A powder that is an assembly of particles made of SUS 316L as first metal particles and a powder that is an assembly of particles made of Cu (ATP-Cu 1.5 μm, manufactured by Nippon Atomized Metal Powders Corporation) as second metal particles were prepared, and these powders were mixed at a predetermined ratio, whereby a three-dimensional shaped article producing powder was obtained.

The first metal particles had an average particle diameter D1 of 3.05 μm, a true density ρ1 of 7.98 g/cm³, a thermal conductivity λ1 at 25° C. of 16.7 W/m·K, and a melting point Tm1 of 1390° C. Further, the reflectance κ1 of the maximum peak wavelength component of the laser beam used in the joining step in the below-mentioned [8] at 25° C. was 60%.

Further, the second metal particles had an average particle diameter D2 of 1.53 μm, a true density ρ2 of 8.96 g/cm³, a thermal conductivity λ2 at 25° C. of 403 W/m·K, and a melting point Tm2 of 1084.5° C. Further, the reflectance κ2 of the maximum peak wavelength component of the laser beam used in the joining step in the below-mentioned [8] at 25° C. was 98%.

### Comparative Example A1

In this Comparative Example, the assembly of particles made of SUS 316L as the first metal particles used in the above Example A1 was directly used as a three-dimensional shaped article producing powder. That is, the three-dimensional shaped article producing powder of this Comparative Example does not include the second metal particles.

The conditions for the three-dimensional shaped article producing powders of the above Example and Comparative Example are collectively shown in Table 1.

TABLE 1

| | First metal particles | | | | | | |
|---|---|---|---|---|---|---|---|
| | | | | | Reflectance of | | |
| | | Average | | | maximum peak | | |
| | | particle | | Thermal | wavelength | | |
| | | diameter | True | conductivity | component of | Melting | Content |
| | Constituent | D1 | density ρ1 | at 25° C. λ1 | laser beam κ1 | point Tm1 | ratio X1 |
| | material | [μm] | [g/cm³] | [W/m · K] | [%] | [° C.] | [mass %] |
| Example A1 | SUS 316L | 3.05 | 7.98 | 16.7 | 60 | 1390 | 90.1 |
| Comparative | SUS 316L | 3.05 | 7.98 | 16.7 | 60 | 1390 | 100 |
| Example A1 | | | | | | | |
| | Second metal particles | | | | | | |
| | | | | | Reflectance of | | |
| | | Average | | | maximum peak | | |
| | | particle | | Thermal | wavelength | | |
| | | diameter | True | conductivity | component of | Melting | Content |
| | Constituent | D2 | density ρ2 | at 25° C. λ2 | laser beam κ2 | point Tm2 | ratio X2 |
| | material | [μm] | [g/cm³] | [W/m · K] | [%] | [° C.] | [mass %] |
| Example A1 | Cu | 1.53 | 8.96 | 403 | 98 | 1084.5 | 9.9 |
| Comparative | — | — | — | — | — | — | — |
| Example A1 | | | | | | | |

### [7] Production of Three-Dimensional Shaped Article Producing Composition

### EXAMPLE B1

The three-dimensional shaped article producing powder obtained in the above Example A1, water as a solvent, and β-cyclodextrin as a binder were mixed at a predetermined ratio, whereby a three-dimensional shaped article producing composition was obtained. The content ratio of the three-dimensional shaped article producing powder in the thus obtained three-dimensional shaped article producing composition was 90 mass %, and the content ratio of the solvent was 0.5 mass %, and the content ratio of the binder was 9.5 mass %.

### Comparative Example B1

A three-dimensional shaped article producing composition was obtained in the same manner as in the above Example B1 except that the three-dimensional shaped article producing powder obtained in the above Comparative Example A1 was used in place of the three-dimensional shaped article producing powder obtained in the above Example A1, and the used amounts of the respective components were adjusted so as to give the composition as shown in Table 2.

The conditions for the three-dimensional shaped article producing compositions of the above Example and Comparative Example are collectively shown in Table 2.

TABLE 2

| | First metal particles | | Second metal particles | | Binder | | Solvent | |
|---|---|---|---|---|---|---|---|---|
| | | Content | | Content | | Content | | Content |
| | | ratio | | ratio | | ratio | | ratio |
| | Composition | [mass %] | Composition | [mass %] | Composition | [mass %] | Composition | [mass %] |
| Example B1 | SUS 316L | 81.0 | Cu | 9.0 | β-cyclodextrin | 9.5 | water | 0.5 |
| Comparative | SUS 316L | 90.0 | — | — | β-cyclodextrin | 9.5 | water | 0.5 |
| Example B1 | | | | | | | | |

### [8] Formation of Sintered Layer

Sintered layers were formed as follows using the three-dimensional shaped article producing compositions of the above Example and Comparative Example.

First, a three-dimensional shaped article production apparatus as shown in FIG. 12 was prepared, and the three-dimensional shaped article producing composition was ejected onto a stage from a nozzle of a dispenser as a composition ejection unit, whereby a layer was formed. The thus formed layer had a thickness of 50 μm, a width of 10 mm, and a length of 60 mm.

Thereafter, the layer was subjected to a heating treatment at 180° C. using a line heater that is a solvent removal unit, whereby the solvent contained in the layer was removed.

Thereafter, for a portion of the layer from which the solvent was removed, a laser beam from a YAG laser that is a laser beam having a maximum peak wavelength of 1064 nm and a beam diameter of 190 μm was allowed to scan, whereby a sintered layer was formed in the layer from which the solvent was removed. The sintered layer had a rectangular parallelepiped shape with a width of 8 mm and a length of 8 mm, and the periphery thereof was surrounded by the layer from which the solvent was removed.

### [9] Evaluation

With respect to the upper face of the layer from which the solvent was removed around the sintered layer formed using each of the three-dimensional shaped article producing compositions of the above Example and Comparative Example, 5 sites were randomly extracted, and the particle diameters of metal particles scattered from the sintered layer were measured using an SEM. Then, the average particle diameter of the metal particles was determined and evaluated according to the following criteria. The region observed using the SEM was determined to be a region on the layer, which is at a distance within 3 mm from the sintered layer, and from which the solvent was removed, and the region in which the particle diameters of the metal particles were measured was determined to be 3 μm square per site.

A: The average value of the maximum height Sz is less than the film thickness.

B: The average value of the maximum height Sz is equal to or more than the film thickness.

The results are collectively shown in Table 3.

TABLE 3

| | Evaluation |
|---|---|
| Example B1 | A |
| Comparative Example B1 | B |

As apparent from Table 3, according to the present disclosure, a three-dimensional shaped article having high dimensional accuracy and high reliability could be stably produced. On the other hand, in Comparative Example, a satisfactory result could not be obtained.

What is claimed is:

1. A three-dimensional shaped article producing powder, comprising a plurality of metal particles, and being used for producing a three-dimensional shaped article by laminating a plurality of layers while joining the metal particles to one another by irradiation with a laser beam, wherein
as the metal particles, first metal particles and second metal particles having a composition different from the first metal particles are included, and
X1>X2 and κ1<κ2, wherein X1 [mass %] is a content ratio of the first metal particles in the three-dimensional shaped article producing powder, X2 [mass %] is a content ratio of the second metal particles in the three-dimensional shaped article producing powder, κ1 [%] is a reflectance of a maximum peak wavelength component of the laser beam at 25° C. with respect to the first metal particles, and κ2 [%] is a reflectance of a maximum peak wavelength component of the laser beam at 25° C. with respect to the second metal particles.

2. The three-dimensional shaped article producing powder according to claim 1, wherein Tm1>Tm2 wherein Tm1 [° C.] is a melting point of the first metal particles, and Tm2 [° C.] is a melting point of the second metal particles.

3. A three-dimensional shaped article producing powder, comprising a plurality of metal particles, and being used for producing a three-dimensional shaped article by laminating a plurality of layers while joining the metal particles to one another by irradiation with a laser beam, wherein
as the metal particles, first metal particles and second metal particles having a composition different from the first metal particles are included, and
X1>X2 and λ1 <λ2, wherein X1 [mass %] is a content ratio of the first metal particles in the three-dimensional shaped article producing powder, X2 [mass %] is a content ratio of the second metal particles in the three-dimensional shaped article producing powder, λ1 [W/m·K] is a thermal conductivity at 25° C. of the first metal particles, and λ2 [W/m·K] is a thermal conductivity at 25° C. of the second metal particles.

4. The three-dimensional shaped article producing powder according to claim 1, wherein 3≤X1/X2≤1000.

5. The three-dimensional shaped article producing powder according to claim 1, wherein the first metal particles have an average particle diameter of 1.0 μm or more and 100 μm or less.

6. The three-dimensional shaped article producing powder according to claim 1, wherein the second metal particles have an average particle diameter of 0.1 μm or more and 10 μm or less.

7. A three-dimensional shaped article producing composition, comprising:
the three-dimensional shaped article producing powder according to claim 1;
a binder; and
a solvent.

8. The three-dimensional shaped article producing composition according to claim 7, wherein a content ratio of the three-dimensional shaped article producing powder is 70 mass % or more and 90 mass % or less.

9. The three-dimensional shaped article producing composition according to claim 7, wherein the three-dimensional shaped article producing composition is ejected by a dispenser when forming the layer.

10. A production method for a three-dimensional shaped article, comprising producing a three-dimensional shaped article by repeatedly performing a series of steps including
a layer formation step of forming a layer using the three-dimensional shaped article producing composition according to claim 7,
a solvent removal step of removing the solvent contained in the layer, and
a joining step of joining the metal particles to one another by irradiating the layer with a laser beam in a predetermined pattern.

11. The production method for a three-dimensional shaped article according to claim 10, wherein
a maximum peak wavelength of the laser beam is 300 nm or more and 1300 nm or less,
a reflectance of a maximum peak wavelength component of the laser beam at 25° C. with respect to the first metal particles is 15% or more and 65% or less, and
a reflectance of a maximum peak wavelength component of the laser beam at 25° C. with respect to the second metal particles is 68% or more and 90% or less.
